(19) United States
(12) Patent Application Publication
(10) Pub. No.: US 2011/0187895 A1
(43) Pub. Date: Aug. 4, 2011

(54) INTELLIGENT VIDEO COMPACTING AGENT

(76) Inventors: Fred Cheng, Los Alto Hills, CA (US); Herman Yau, Palo Alto, CA (US)

(21) Appl. No.: 12/699,752

(22) Filed: Feb. 3, 2010

(51) Int. Cl. H04N 5/228; H04N 7/173; H04N 7/12

(52) U.S. Cl. 348/231.2; 725/118; 725/109; 375/240.01; 348/E05.031; 375/E07.076

(57) ABSTRACT

A method of capturing images comprises capturing a video image and converting the video image to a digital video image. The method performs at least one operation on the digital video image and communicates the operated digital video image to at least one of two paths with at least one of the paths being a remote destination and at least another path being a local destination. The method determines whether an event occurs in the video image and selects the path based on the event. The method stores the operated digital video image on a memory at the remote destination if the event occurs in addition to storing the digital video image on a memory at the local destination.

### FIELD OF THE INVENTION

The present disclosure is directed to a system for automatic and continuous remote data storage of an output of a digital video camera. More particularly, the present disclosure is directed to remote data storage of digital video that is compressed and processed to improve a quantity of remote storage and to allow remote storage in an improved continuous and rapid manner.

### BACKGROUND OF THE RELATED ART

Prior art surveillance applications are known in the art. The surveillance applications include a digital video camera connected to a digital video recorder.

Generally, the digital video recorder has a memory and is operatively connected to the digital video camera close by. When motion is detected inside the predetermined area, video capture can be activated. Digital or analog video data can then be recorded on to the local recorder.

The digital video camera may also include methods to increase an amount of video that can be stored on the digital video recorder. For example, the digital video camera may compress the images and record a time stamp indicating the day, hour, minute and second associated with the capture of the image.

Other prior art surveillance applications may include a backup memory that is located a distance away from the digital video camera and the local digital video recorder. To protect the recorded video data file from being stolen or destroyed by an intruder, the recorded video data can be transmitted to a remote server for secured storage. The local digital video recorder only provides local video compression and storage. Generally, the communication network associated with the digital video camera and digital video recorder is limiting.

The prior art does not allow a user to continuously and automatically select whether to transmit the video data to a path associated with a local digital video recorder or a path associated with the local digital video recorder and a remote memory and to process the video data based on the content of the video data.

### SUMMARY OF THE INVENTION

According to a first aspect of the present disclosure, there is provided a method of capturing images. The method comprises capturing a video image and converting the video image to a digital video image. The method performs at least one operation on the digital video image and communicates the operated digital video image to at least one of two paths with at least one of the paths being a remote destination and at least another path being a local destination. The method determines whether an event occurs in the video image and selects the path based on the event. The method stores the operated digital video image on a memory at the remote destination if the event occurs in addition to storing the digital video image on a memory at the local destination.

In yet another aspect of the present disclosure there is provided a video capture system comprising a video camera and a computing device coupled to the video camera. The computing device has a processor and a memory. The system also has a network connection coupled to the computing device. The network connection is for communicating data to a remote memory. The video camera captures images and communicates the captured image to the computing device. The computing device determines at least one parameter of the video image and stores the video image on (i) the local memory or (ii) on the local memory in addition to the remote memory based on the at least one parameter.

In another embodiment of the present disclosure, there is provided a video capture system. The system has a digital video camera and a computing device coupled to the digital video camera. The computing device has a processor and a local memory. The system also has a network connection being coupled to the computing device and the network connection is for communicating data to a remote memory. The digital video camera captures images and communicates the captured images to the computing device. The computing device determines at least one parameter of the video image and stores the video image on (i) the local memory or (ii) on the local memory and on the remote memory based on the at least one parameter. A path of the digital video images is modulated based on the at least one parameter. The digital video images are processing based on the at least one parameter.

According to yet another embodiment of the present disclosure there is provided a recordable medium comprising program instructions for capturing video images and program instructions for directing the captured video images to (i) a local memory or (ii) the local memory and a remote memory. The medium also includes program instructions for assigning a priority to the captured video images and transferring the captured video images to (i) the local memory or (ii) to the local memory and to the remote memory based on the priority of the images in a non-sequential manner.

According to yet another embodiment of the present disclosure there is provided a system comprising a camera for capturing video images and an agent for directing the captured video images to (i) a local memory or (ii) the local memory and a remote memory. The system also has a controller for assigning a priority to the captured video images and transferring the captured video images to the local memory or to both the local memory and the remote memory based on the priority of the images.

According to yet another embodiment of the present disclosure there is provided an agent. The agent comprises a module for receiving digital video images and audio data. The agent directs the captured video images to (i) a local memory or (ii) the local memory and a remote memory. The agent is hardware or software, or a combination of hardware and software.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, the drawings are illustrative of certain ways of performing the invention. Others will be readily apparent to those skilled in the art.

FIG. 1 shows a system diagram according to the present disclosure;

FIG. 2 shows a general purpose computer operatively connected to a video camera for using the video camera with a software platform controlled by an input device; and

FIG. 3 shows a number of method steps for a method of determining whether the images are to be recorded on a local memory or recorded on the local memory and a remote memory and whether the images are communicated over a number of different paths.

### DETAILED DESCRIPTION OF THE PREFERRED EMBODIMENTS

The present disclosure preferably is directed to an intelligent video compacting agent that permits an automatic backup of video data in a remote and continuous manner. The present disclosure preferably has an agent 20 that may direct digital data to either a first path or a second path. The first path is from the digital video camera 12a, 12b, 12c, 12d to a local digital video recorder 18. The second path is from the digital video camera 12a, 12b, 12c, 12d or the local digital video recorder 18 and to a remote destination or a remote memory, which is located operable on a remote server 36. The second path can be communicated via a wireless or wired method. For example, the communication path can be communicated by a Network router, a Wi-Fi dongle, a Wi-Fi Router, Wi-Max, Cellular Phone Network or a wireless protocol shown as reference numerals 24a, 24b, 24c.

Preferably, the agent 20 records continuously to the local memory 18. In some instances, the agent 20 may also record to the local memory 18 and the remote memory 36. A software developer may create source code typically in a high-level software program and the agent 20 may be implemented in software, hardware, firmware, as program instructions, an application, a software platform or any combination thereof as discussed below. In another less preferable embodiment, the agent 20 may record to only one of the local memory 18, or the remote memory 36. In a further less preferable embodiment, the agent 20 may be software that communicates the data to a third entity and the third entity may communicate the data to the local memory 18 or the remote memory 36. In a further less preferable embodiment, the agent 20 may distribute the data to more than two locations, including the local memory 18 and the remote memory 36.

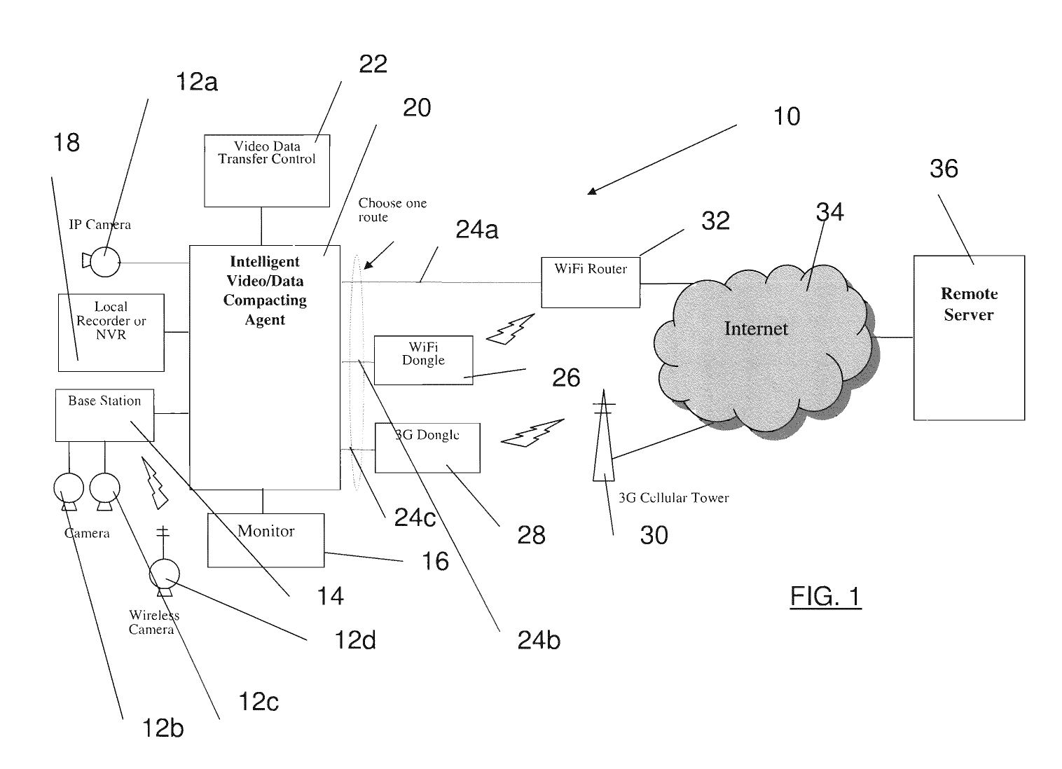

Turning now to FIG. 1, there is shown a system 10 for automatically processing digital video data and automatically making copies of the data so that these additional copies may be used to restore the original after a data loss event. The system 10 includes a first digital video camera 12a, a second digital video camera 12b, a third digital video camera 12c and a fourth digital video camera 12d. The first through third digital video cameras 12a, 12b and 12c are connected to a video/data compacting agent 20 in a wired manner by a coaxial cable or the like while the fourth digital video camera 12d is preferably connected to the agent 20 in a wireless manner. The fourth digital video camera 12d is wirelessly connected to a base station 14. The first digital video camera 12a is coupled directly to the agent 20 while the second and the third digital video camera 12b and 12c are coupled to the base station 14, which is coupled to the agent 20.

The first through fourth digital video cameras 12a through 12d are preferably cameras that take video or still photographs, or both, digitally by recording images via an electronic image sensor. The first through fourth digital video cameras 12a through 12d can be closed-circuit television cameras, generally used for security, surveillance, and/or monitoring purposes. The first through fourth digital video cameras 12a through 12d can be small, easily hidden, and able to operate unattended for monitoring a predetermined area for long periods of time. For example, the first through fourth digital video cameras 12a through 12d can be webcams operable for use as a closed circuit television camera. The first through fourth digital video cameras 12a through 12d each may convert a signal from the electronic image sensor directly to a digital output and can incorporate a circuit to directly interface with a specific protocol into the base station 14 and the agent 20.

Alternatively, the first through fourth digital video cameras 12a through 12d can interface and output a digital signal to a video and data monitoring device 16 such as a computer or communications hardware, particularly mobile phones, a Personal Digital Assistant, a net book, a desktop, and predetermined models of laptop computers. The first through fourth digital video cameras 12a through 12d may further pass an output through an analog-to-digital converter in order to store the output or send the output to a wider network. The digital video may be H.261, H.263, H.264, JPEG, MJPEG, MPEG or any other digital video formats.

Base station 14 preferably receives the signal from the second through fourth digital video cameras 12b through 12d and communicates the signal to the intelligent video and data compacting agent 20 as opposed to the first digital video camera 12a, which is directly connected to the agent 20. The base station 14 is preferably a radio receiver/transmitter that serves as the hub of a local wired or wireless network formed from a number of digital video cameras 12b, 12c, 12d and other optional components of the system 10. Base station 14 is preferably a gateway between a wired network and the wireless network. Base station 14 comprises a housing including a low-power transmitter and wireless router for facilitating communication between the digital cameras 12b, 12c and 12d and the agent 20.

The system 10 also has a local digital video recorder 18, which is connected to the agent 20. Local digital video recorder 18 receives digital data from the first through the fourth digital video cameras 12a through 12d. The local digital video recorder 18 is a device that records video in a digital format to a disk drive or other memory medium within a device. The local digital video recorder 18 may be a low cost device and may include a stand-alone set-top box, a portable media player, or a personal computer having a software program that enables video capture and playback to and from disk. The local digital video recorder 18 may also be a hard drive or a device that is incorporated into a monitor 16 with hardware and software built in to the monitor 16 itself.

The local digital video recorder 18 is preferably configured and has an appropriate memory size for physical security applications, for example, 500 GB memory or less, 1TB, 2TB, 4TB, 8TB or more or the like. The local digital video recorder 18 may record audio and video signals from closed circuit television cameras for detection and documentation purposes. The local digital video recorder 18 may optionally monitor and optimize memory usage and may be programmed to overwrite the oldest security footage should the memory of the local digital video recorder 18 becomes full. In one embodiment, the local digital video recorder 18 may record substantially all of the audio and video signals from closed circuit television cameras for detection and documentation purposes.

The system 10 further includes an intelligent video/data compacting agent 20. The agent 20 can be of the form of hardware, software or a merger of hardware and software. It can be ported into a hardware such as a camera 12a, 12b, 12c, or 12d, a control box, a computer, or electronic device and place the function/features into many different hardware or software devices. Agent 20 may alternatively be a in the form of program instructions in a software program and loaded on a memory associated with the camera 12a, DVR 18 or another component of the system 10. The agent 20 can be either in software, hardware, and firmware and includes any written programs, procedures or rules and associated documentation pertaining to the operation of a computer system and the system 10. It should be appreciated that the agent 20 shown in FIG. 1 may include various different embodiments and is not limited to hardware alone.

The intelligent video/data compacting agent 20 is connected to a video data transfer control device 22 and a monitor 16, which permits the user to graphically interface with the system 10 and to optionally monitor the output from the first through fourth digital video cameras 12a-12d. The intelligent video/data compacting agent 20 advantageously directs data along one or at least two different paths. The first path is from the first through fourth digital video cameras 12a-12d to the local digital video recorder 18 for recordation purposes. Preferably, the data from each of the cameras 12a-12d is continuously recorded to the local memory or DVR recorder 18. The second path is from the first through fourth digital video cameras 12a-12d to a remote destination for storage purposes. The selection of the first or the second path may be made in a continuous and automatic manner and may further be made based on the specific content of the images captured by the first through fourth digital video cameras 12a-12d.

The two paths that video/audio data are sent is herein described. Data from each of the cameras 12a to 12d is delivered to the local memory 18. Preferably, the local memory 18 receives the video and audio data. The data undergoes a basic compression plus basic processes through either agent 20 or from the specific camera 12a, 12b, 12c, and 12d directly. The compressed data is then stored directly at local memory 18 substantially continuously regardless if the system 10 detects motion, detects an alarm or detects an object in the field of vision of the specific camera 12a-12d or otherwise determines if there is any adversary situation to indicate that an intruder entered the protected premises. Data from the specific camera 12a-12d is delivered to the remote memory 36 along the second path for remote storage purpose.

In some instances, video and audio data is sent from the specific camera 12a-12d to the agent 20 and to the remote memory 36 for storage. The video and audio data undergoes basic compression and basic and advanced process operations. The data can be delivered in a specific manner and according to a predetermined schedule. For example, data can be transmitted according to a pre-scheduled operation such as, for example, commencing at 10:00 am daily. Data can also be transmitted according to an urgent situation such as when in an adversary situation. For example, if an alarm is activated, this may indicate that an intruder has entered the field of view of the cameras 12a-12d and the agent 20 may deliver the data to both the local memory 18 and to the second path to the remote memory 36 to assist with apprehension of the intruder as the intruder may have access to the local memory 18 but not the remote memory 36.

The data sent to the remote memory 38 may undergo basic compression and may include one or more video/audio compression schemes including, but not limited to JPEG, MJPEG, MPEG, H.264, and any other compression scheme known in the art. The data sent to the remote memory 38 may undergo basic process operations including a time stamp and other operations. The data sent to the remote memory 38 may undergo advanced processes including inactive frame removal, face detection, area detection, and other processes known in the art to promote apprehension of an intruder and to capture and record high quality video and high quality audio.

The intelligent video/data compacting agent 20 may further perform a digital processing operation on the video data received from at least one of (or all of) the first through fourth digital video cameras 12a-12d. The operation can be the compression of the data received from at least one of the first through fourth digital video cameras 12a-12d. For example, the compression may be operable with a motion detection feature whereupon if no motion is detected, then a predetermined number of frames may be removed from the data as redundant data.

For example, if motion is detected, then the predetermined number of video frames are not removed, and recorded as the data is deemed highly relevant. Preferably, the compression of the data permits communication of the data at a relatively higher data rate over a transmission medium. Alternatively, the processing operation may be operable with an external alarm signal received from an alarm. If an alarm is activated, then the agent 20 can control the first through fourth digital cameras 12a-12d to capture video and to record the captured data in local memory 18 or remote memory 36 in response to the external alarm signal. Further, the agent 20 can also control the first through fourth digital cameras 12a-12d to record data in response to the detection of a predetermined object or portion of an object that appears within the field of view of the first through fourth digital video cameras 12a-12d.

For example, the agent 20 may control the specific digital camera 12a-12d to initiate recording or magnify an image in response to a signal that an alarm has been triggered (door alarm, motion detector alarm). If no alarm is detected, then a predetermined number of frames may be removed from the data as redundant data or the image is not magnified as the image is simply the same images as the previously recorded image and is redundant. If an alarm is detected, then the video frames are not removed and the image is not compressed. The images are recorded or even magnified, or recorded with a higher resolution as the data is deemed highly relevant. This may indicate that an intruder has gained access to the space and high resolution images are desired to capture the relevant video data. Agent 20 may also control the cameras 12a-12d to pan, tilt and zoom in response to a detected object, alarm, or motion.

Additionally, the agent 20 may control the specific digital camera 12a-12d to initiate recording or magnify an image in response to the detection of a specific number of pixels in a pattern that assumes that a specific object is in the video image. For example, a specific number of pixels arranged in the form of a human body, or in the form of a vehicle, or headlights may enter the field of view of the cameras 12a-12d and the processor 22 can detect and assume that an intruder has entered into the protected space. If no object is detected in the recorded image, then a predetermined number of frames may be removed from the data as redundant data. For example, if an object or a portion of the object is detected, then the video frames are not removed. The video data can then be recorded or even magnified, or recorded with a higher resolution as the data is deemed highly relevant. The agent 20 may further embed or incorporate data into the captured video image. The embed data can be text such as the day, hour, minute, second, camera identification information (Camera 1, Camera 2, etc.), alarm, object presence, event data, or any other identification data known in the art. The agent 20 may further embed or incorporate metadata into the captured video image. For example, if an object is detected, the agent 20 may embed “intruder detected” and the date and time into the lower right hand corner of the video image. In this manner, the user may only select parameters to display only relevant video data when reviewing to ensure that the user does not have to review all of the video data.

Preferably, the agent 20 will route the data received from the first through the fourth digital video cameras 12a-12d along the first path or the second path based on whether the data is processed by the agent 20 or not. The processed data is communicated to the local memory 18 and also along the second path to the remote destination 36.

The agent 20 is primarily a process and may be configured as a number of program instructions that are loaded on a component of the system 10 alone. The process can be deployed on a dedicated hardware device, such as, for example a base station 14, computing device, or in the network camera 12a-12d or on the network video recorder 18, or as mentioned distributed among a few hardware devices. It should be appreciated that the intelligent video/data compacting agent 20 may be hardware, or alternatively may be software stored as program instructions on a memory associated with the network camera 12a, 12b, 12c, 12d, a digital video recorder, a server, base station 14, a network device, a circuit or any server or hardware device associated with the system 10. Various agent 20 configurations are possible and within the scope of the present disclosure. In yet another less preferable embodiment, the agent 20 may be loaded on or be a part of a software platform in a cloud computing arrangement and the digital cameras 12a-12d may communicate the data to the cloud computing arrangement.

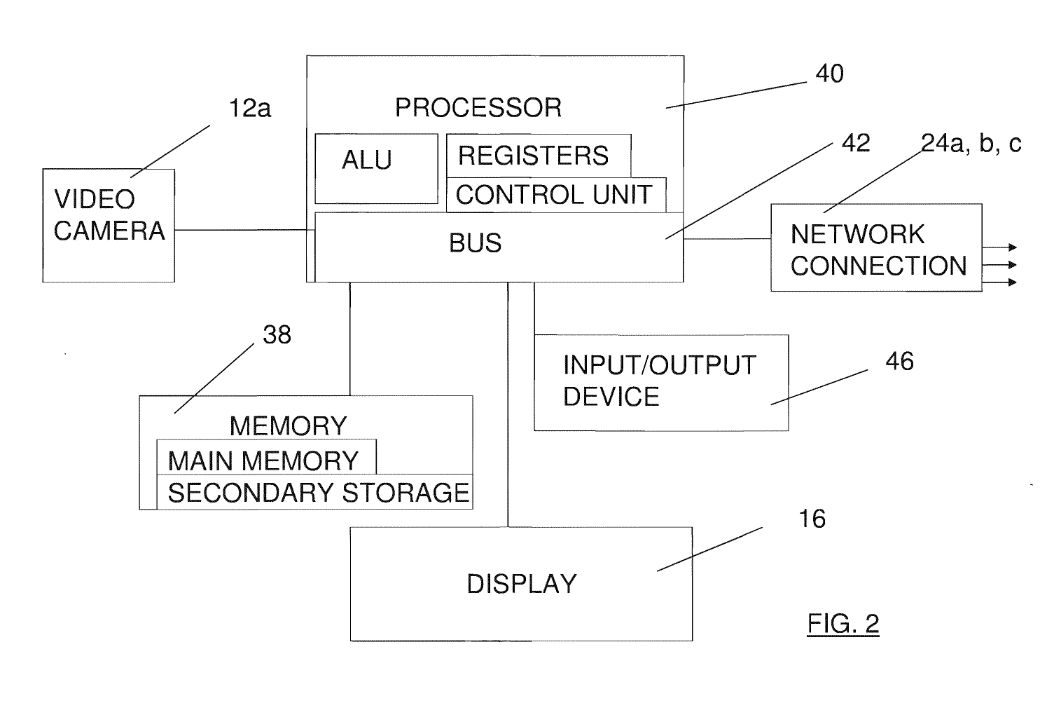

Preferably, the data is communicated to the local memory 18 and to the second path. The data may be communicated to a remote server 36 associated with the remote destination. The second path may take various forms to communicate the data to the remoter server 36. For example, the agent 20 may be connected along path 24a to a Network Router (not shown) or Wi-Fi router 32, which communicates the digital information across the Internet 34 to the remote server 36. The agent 20 may be connected to a software platform accessible form the Internet 36. The software platform can be a SEEDONK® Video Management platform. The software platform can be a video monitoring and a video sharing application and is a consumer platform for viewing, managing and sharing cameras over the Internet. The software platform is operable on a personal computer, a mobile communication device, a network appliance, or is operable on a server. The computer running the first software platform may be a cloud computing configuration or may include a memory 38, a processor 40, a bus 42, a display 16, a user interface 46 and an internet connection 24a, 24b, 24c as shown in FIG. 2. Preferably, the bus 42 in one embodiment can be directly connected to the agent 20 and the video camera 12a, however, the computing device likely is a distance away from the camera 12a and the bus 42 is connected to the agent 20 via network connection 24a. The computing device of FIG. 2 forms no limitations to the present disclosure and is merely illustrative of one non-limiting embodiment. For example, the software platform can view the output of the digital video camera 12a-12d, or can control the digital video camera 12a-12d to pan, tilt, zoom or perform any other control functions associated with the first digital camera.

Agent 20 may also be coupled to a Wi-Fi dongle 26. A dongle 26 is a small piece of hardware that connects to the agent 20, or a laptop or desktop computer. Dongle 26 acts as a broadband wireless adaptor or in general is a connector that translates one type of port to another and that facilitates the transfer of digital data from one component of the system 10 to the remote server 36. Dongle 26 is connected to the agent 20 through path 24b which enables the connection to at least one network camera 12a, 12b, 12c, 12d and data can be communicated in a wireless manner in a specific protocol to be received by a wireless router 32, which is connected to the Internet 34 to communicate with the remote destination at the remote server 36.

Agent 20 may alternatively be coupled to a 3G dongle 28 along path 24c. 3G refers to the International Mobile Telecommunications-2000 (IMT-2000) or the 3rd Generation standards for mobile telecommunications defined by the International Telecommunication Union. 3G preferably includes at least one of GSM, EDGE, UMTS, and CDMA2000 as well as TDSCDMA, DECT and Wi-MAX. 3G may further include a wide-area wireless voice telephone, video calls, and wireless data, all in a mobile environment that allows simultaneous use of speech and data services and higher data rates of up to about 14.0 Mbit/s on the downlink and about 5.8 Mbit/s on the uplink.

A 3G dongle 28 is a broadband wireless adaptor or a connector that translates one type of port to another. 3G dongle 28 facilitates the transfer of digital data from one component of the system 10 to the remote server 36 over a wireless telecommunication network via a telecommunication base station. Dongle 28 is operatively connected to at least one network camera 12a, 12b, 12c, 12d via the agent 20. Data can be communicated along path 24c and then through 3G dongle 30 in a wireless manner in a specific protocol to be received by a nearby base station 30 and then to its central station (not shown), which is connected to the Internet 34 to communicate with the remote destination at the remote server 36. It should be appreciated that the transfer of digital data is achieved in packets over a specific predetermined frequency. Wireless telecommunications network 30 is generally implemented with some type of remote information transmission system that uses electromagnetic waves, such as radio waves, for the carrier. The implementation usually takes place at the physical level or “layer” of the network. Alternatively, in a further embodiment, the agent 20 may communicate with the server 36 with a different standard, such as, for example the IEEE 802.16 standard.

The system 10 further includes a video data transfer controller 22. Video transfer controller 22 can be manufactured as a separate hardware element or a separate software element, or can be alternatively incorporated into the agent 20. Preferably, the video transfer controller 22 may include an input device 46. A user by using the input device 46 in association with the software platform may control one or more attributes of the agent 20. For example, the controller 22 may control a rate that the video and audio is transmitted along the paths. Controller 22 may set a data rate from one or more choices so that the internet bandwidth along the paths is commensurate with the objectives of the user. For example, the controller 22 may set a data rate according to the status of the current Internet traffic so that the video and data transmission will not fully occupy the bandwidth when traffic is busy. When the Internet connection is not busy such as during off business hours, the video transfer rate can be set to a higher level to accomplish a backup of all video data at the remote server 36 in a rapid manner. Various data rate configurations are possible and within the scope of the present disclosure. It should be appreciated that the video compression may even permit the transfer of video over a relatively small bandwidth.

Controller 22 also may control the agent 20 to determine a predetermined schedule of what data is transferred along the first or the second path and the time interval for transmitting data to the remote server 36. Preferably, the data is continuously loaded along the first path to the local memory 18, and selectively transmitted to the second path to the remote memory 36. For example, using the software platform from the Internet 34, the user can control controller 22 via input device 46 to determine when a periodic backup of data occurs. For example, the user may schedule a time slot of Monday at 1:00 a.m. for a full backup of the memory associated with the digital video recorder 18. This can be an hour whereupon little traffic is expected and whereupon a backup can occur in a rapid manner and when no other users are on the network. Additionally, after a period of time, the agent 22 will record data and compress the data by a frame removal operation. Therefore, a backup of the data can occur in a rapid manner as relatively less data is required to be transmitted as redundant data has been removed and only important or critical data is retained or sent to the remote server 36.

Furthermore, the controller 22 may prioritize certain data recorded by the digital video camera 12a-12d as critical and higher priority and other data as low priority. For example, a user using a software platform may notice that an intruder is present in the field of view of one or more of the cameras 12a-12d. The user will then control input device 46 to send a signal to the controller 22 to mark the data as high priority. In other embodiments, the software may receive an alarm signal or detect an intruder and mark the video as high priority. The data marked as high priority will be immediately or rapidly transmitted from the first path to the local digital video recorder 18 and to the second path and delivered to the remote server 36 along the Internet 34. The critical data will take precedence over other data than is schedule for a periodic transfer. Preferably, the data is continuously loaded along the first path to the local memory 18, and selectively transmitted to the second path to the remote memory 36.

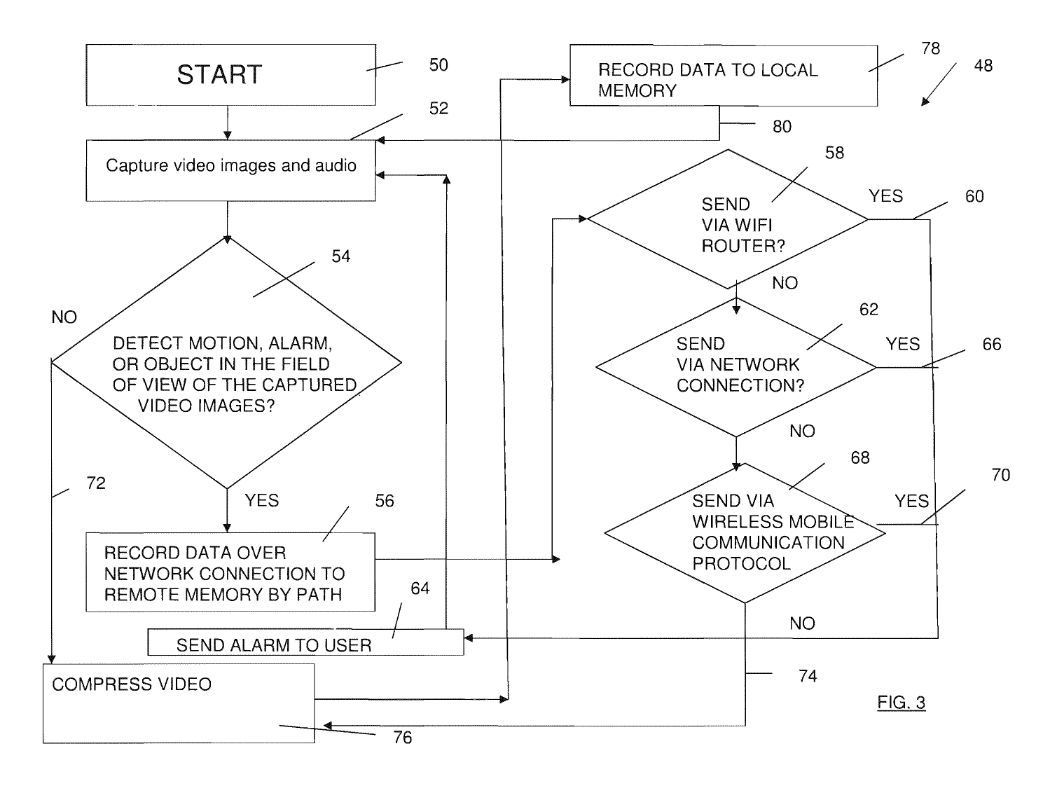

Turning now to FIG. 3, there is shown a method according to the present disclosure as reference numeral 48. The method 48 commences at step 50 and passes to step 52 where digital video images and audio are recorded. Preferably, the data is continuously loaded along the first path to the local memory 18. The local memory 18 receives data that undergoes a basic compression operation plus a basic processing operation (step 76). The compression and processing may be from the specific camera 12a, 12b, 12c and 12d, the agent 20, or the digital video recorder 18 (step 76). The compressed data is stored directly at local memory 18 (step 78) all the time and it does not matter if there is any alarm, motion detected or object detected that would indicate an adversarial situation. It should be also appreciated that the method steps are not limited to the hierarchal order shown and some steps can be performed before others and some steps can be performed simultaneously. Various configurations of the present method are possible and within the scope of the present disclosure.

In one embodiment of the present disclosure using a motion detector, an alarm or recognition software applications, for example, the controller 22 may receive a signal from an alarm (not shown) that a break in has occurred, a motion detector has been activated, or an object has been recognized in the field of view of at least one of the digital cameras 12a-12d (step 54). Controller 22 will then control agent 20 to mark the data as high priority. Generally, all images are recorded at the local digital video recorder 18. However, for urgent images the data marked as high priority will be immediately and rapidly transmitted from the first path to the local digital video recorder 18 to the second path and delivered to the remote server 36 along the Internet 34. Preferably, the data is continuously loaded along the first path to the local memory 18, and selectively transmitted to the second path to the remote memory 36.

If at step 54, an object, motion or an alarm is detected then control passes along from step 54 to step 56. At step 56, the data is deemed as urgent or critical material and thus determined to be delivered to the remote memory 36 immediately. The control passes along from step 56 to step 58 where it is determined whether the data is to be send to the remote memory 36 via a Wi-Fi router. If appropriate to be delivered by the Wi-Fi router then control passes along line 60 to step 64 where the data is transmitted to remote memory 36 and where an additional alarm message is sent to a user to review the data as a possible break in has occurred. Sending the alarm message can be accomplished via SMS, e-mail, signal or via the software platform as discussed.

If not appropriate to be delivered by the Wi-Fi router at step 58 then control passes to step 62. At step 62, the data is deemed as urgent or critical material and it is determined whether the data is to be sent to the remote memory 36 via a network connection via the Internet as shown in FIG. 1. If appropriate to be delivered by the network connection then the data is transmitted to the remote server 36 and control passes along line 66 to step 64 where the data is transmitted to remote memory 36 and where an additional alarm message is sent to a user to review the data as a possible break in has occurred. Sending the alarm message can be accomplished via SMS, e-mail, signal or via the software platform as discussed. If not appropriate to be delivered by the network connection at step 62 then control passes to step 68.

At step 68, the data is deemed as urgent or critical material and it is determined whether the data is to be send to the remote memory 36 via mobile communication protocol. If appropriate control passes along line 70 to step 64 where the data is transmitted to the remote memory 36 and an alarm message is sent to a user to review the data as a possible break in has occurred. Thereafter control passes from step 64 to step 52 to continue capturing video and audio images. It should be appreciated that the data can be transmitted immediately to the remote server 36 at steps 58, 62, and 68 or by a predetermined schedule or priority.

Preferably, the data recorded on the local memory 18 includes basic compression operations and basic process operations. The operations can be made through either the agent 20, the camera 12a-12d or from the digital video recorded 18 shown as step 78. The compressed data is then stored directly at local memory 18 all the time and does not matter if there is any adversary situation detected. If at step 54, (i) no motion, alarm nor object is detected in the field of view of the images or at step 68 then control passes along lines 72 or 74 to step 76. At step 76 the digital video data is compressed and processed and the digital data is recorded on the local digital video recorder 18 (step 78).

Thereafter, control passes along line 80 to step 52 to continue capturing video images and audio. It should be appreciated that video and audio recording by the first path to local memory 18 preferably occurs in a continuous manner. The local recording is not be interrupted by the setting or decision of controller 22. Preferably, the audio and video will be recorded at local memory 18. The recorded video can then be send to remote memory 36 at a scheduled time for backup purposes. But when adversary situation happens (i.e., when an object is detected, or when motion is detected, or when an alarm sounds), the video data will be sent to both to the first and the second path at the same time. Therefore, the video data can be recorded at the remote memory 36 and the local memory 18 at the same time. In case the local memory 18 is accessible by the intruder and the intruder may tamper and destroy video prior to leaving the protected space, the user still has important video recorded and stored at the remote memory 36, which is not accessible by the intruder.

In a further embodiment of the present disclosure, the agent 20 embeds data or metadata into the digital data associated with the video and audio. The embed data may indicate that an event occurred and that the user should review the digital video image and may include data to assist with locating the video and audio that corresponds to the event. The embed data enables the user to quickly find the relevant high priority data without having to view hours of irrelevant video data. The embed data also enables the user to search, retrieve and review the data using the software platform in a rapid manner. The agent 20 reduces the amount of data transmitted to the remote server 36. The agent 20 also increases the amount of storage capacity available. The agent 20 provides that redundant data is not transmitted to the remoter server 36 and is eliminated. This also reduces any bottlenecks in transferring data and lowers costs associated with storage of the data at the remote server 36. Moreover, if an intruder successfully breaks into the protected space, the intruder does not have access to the data transmitted over the remote server 36 and this may lead to apprehension of the intruder and assist the police.

In a further embodiment of the present disclosure, the agent 20 preferably may further deliver a signal to the user via an SMS, MSM, MSN®, YAHOO®, GOOGLE®, SKYPE®, AOL® instant message, e-mail, phone call, or voicemail message to indicate that a high priority critical video image or audio data has been recorded by at least one of the digital video cameras 12a-12d. Message may be a signal that an alarm has been activated, a motion detector has been activated or an object has been recognized indicating that an event occurred and that the user should review the digital video image. The message may also identify or provide a link or hyperlink to the digital video data. User may then use a Personal Digital Assistant, an Apple® I-PHONE®, BLACKBERRY® device, MOTOROLA® DROID®, GOOGLE®/HTC® NEXUS ONE® phone, laptop, net book, desktop or other Internet communication devices to login to the software platform and access the video to remotely monitor the area via the digital cameras 12a-12d on a real-time basis. The software platform may also send the video and audio data along the second path to the user's device to enable the user to quickly find the relevant high priority data without having to view hours of video data in real time. Moreover, if an intruder successfully breaks into the protected space, the user may be alerted and call the authorities without having to pay for an individual to monitor the space and the intruder may be apprehended. The user may also assist the police by transferring the video data to the police using the software platform or via a computer.

Generally, in operation, the computer system operable with that method shown in FIGS. 1-3 is controlled by an operating system. Typical examples of operating systems are MS-DOS, Windows95, 98, 2000, XP, Vista and Windows 7 from Microsoft Corporation, or Solaris and SunOS from Sun Microsystems, Inc., UNIX based operating systems, LINUX based operating systems, or the Apple OSX from Apple Corporation. As the computer system operates, input such as input search data, database record data, programs and commands, received from users or other processing systems, are stored on storage device. Certain commands cause the processor to retrieve and execute the stored programs. The programs executing on the processor may obtain more data from the same or a different input device, such as a network connection. The programs may also access data in a database for example, and commands and other input data may cause the processor to index, search and perform other operations on the database in relation to other input data. Data may be generated which is sent to the output device for display to the user or for transmission to another computer system or device. Typical examples of the computer system are personal computers and workstations, hand-held computers, dedicated computers designed for a specific purpose, and large main frame computers suited for use many users. The present invention is not limited to being implemented on any specific type of computer system or data processing device.

It is noted that the present invention may also be implemented in hardware or circuitry which embodies the logic and processing disclosed herein, or alternatively, the present invention may be implemented in software in the form of a computer program stored on a computer readable medium such as a storage device. In the later case, the present invention in the form of computer program logic and executable instructions is read and executed by the processor and instructs the computer system to perform the functionality disclosed as the invention herein. If the present invention is embodied as a computer program, the computer program logic is not limited to being implemented in any specific programming language. For example, commonly used programming languages such as C, C++, JAVA as well as others may be used to implement the logic and functionality of the present invention. Furthermore, the subject matter of the present invention is not limited to currently existing computer processing devices or programming languages, but rather, is meant to be able to be implemented in many different types of environments in both hardware and software.

Furthermore, combinations of embodiments of the invention may be divided into specific functions and implemented on different individual computer processing devices and systems which may be interconnected to communicate and interact with each other. Dividing up the functionality of the invention between several different computers is meant to be covered within the scope of the invention.

While this invention has been particularly shown and described with references to a preferred embodiment thereof, it will be understood by those skilled in the art that is made therein without departing from the spirit and scope of the invention as defined by the following claims.

What is claimed is:

1. A method of capturing images comprising:
capturing a video image and converting the video image to a digital video image;
performing at least one operation on the digital video image;
communicating the operated digital video image to at least one of two paths or both with at least one of the paths being a remote destination and at least another path being a local destination;
determining whether an event occurs and selecting the path based on the event; and
storing the operated digital video image on a memory at the remote destination if the event occurs in addition to storing the digital video image on a memory at the local destination.

2. The method of claim 1, wherein the operated video image is communicated to the remote destination in a wireless or wired manner.

3. The method of claim 1, wherein the operated video image is communicated to the remote destination via the Internet.

4. The method of claim 1, further comprising detecting motion in the video image and storing the operated digital video image on the memory at the remote destination when the motion in the video image is detected.

5. The method of claim 4, further comprising detecting motion in the video image and storing the video image at the remote destination when the motion is detected while continuously storing the digital video image on the memory at the local destination.

6. The method of claim 1, further comprising compressing the digital video image to compact the digital video image prior to communicating the operated digital video image to the remote destination.

7. The method of claim 1, further comprising detecting an alarm associated with a location where the video image is being captured and storing the operated digital video image on the memory at the remote destination when the alarm is activated.

8. The method of claim 7, further comprising detecting the alarm associated with a location where the video image is being captured and storing the operated digital video image on the local memory in a substantially continuous manner when the alarm is activated or remains inactivated.

9. The method of claim 1, further comprising determining if the event occurs and modulating the digital image in response to the event.

10. The method of claim 9, wherein the event is motion in the video image and wherein if motion is not detected in the video image then the digital image is compacted by at least a removal of a video frame per unit time.

11. A video capture system comprising:
a video camera;
a computing device being coupled to the video camera, the computing device comprising a processor and a memory;
a network connection being coupled to the computing device, the network connection for communicating data to a remote memory; and
the video camera capturing images and communicating the captured image to the computing device, the computing device determining at least one parameter of the video image and storing the video image on (i) the local memory or (ii) on the local memory in addition to the remote memory based on the at least one parameter.

12. The video capture system of claim 11, wherein the parameter comprises motion in the video image, detection of an object, activation of an alarm, an event, a predetermined schedule, a data rate and any combinations thereof.

13. The video capture system of claim 11, further comprising compressing the video image based on the parameter and communicating the compressed video images to the remote memory.

14. The video capture system of claim 13, wherein the parameter is detected motion, and wherein if no motion is detected and then compressing the video images and communicating the video images to (ii) the local memory and the remote memory.

15. The video capture system of claim 14, wherein the parameter is detected motion, and wherein if motion is detected then not compressing the video images and communicating the video images to (ii) the remote memory and the local memory.

16. The video capture system of claim 15, wherein the parameter is detected motion, and wherein if motion is detected and then not compressing the video images and communicating an alarm to at least one user.

17. The video capture system of claim 11, wherein the parameter is a detected object, and wherein if the object is detected then not compressing the video images and communicating the video images to (ii) the remote memory and the local memory.

18. The video capture system of claim 17, wherein the parameter is the detected object, and wherein if the object is detected then not compressing the video images and communicating an alarm to at least one user.

19. The video capture system of claim 11, further comprising communicating the digital video image to at least one of two paths with at least one of the paths being a remote destination and at least another path being a local destination, wherein the processor determines whether an event occurs in the video image and selecting the path based on the event.

20. A video capture system comprising:
a digital video camera;
a computing device being coupled to the digital video camera, the computing device comprising a processor and a local memory;
a network connection being coupled to the computing device, the network connection for communicating data to a remote memory; and
the digital video camera capturing images and communicating the captured image to the computing device, the computing device determining at least one parameter of the video image and storing the video image on (i) the local memory or (ii) on the local memory and on the remote memory based on the at least one parameter;
a path of the digital video images being modulated based on the at least one parameter; and
the digital video images being processing based on the at least one parameter.

21. The video capture system of claim 20, further comprising at least two paths with a first path being a communication path to a local memory and a second path being a communication path to the local memory and the remote memory.

22. The video capture system of claim 21, further comprising processing the digital video images by enhancing the video images.

23. The video capture system of claim 21, further comprising processing the digital video images by compressing the video images

24. The video capture system of claim 21, further comprising processing the digital video images by enhancing a portion the video images, wherein the portion is a portion of an object recorded in the video image.

25. The video capture system of claim 21, further comprising processing the digital video images by detecting an object or a portion of an object in the video images, and magnifying the detected object.

26. The video capture system of claim 21, further comprising processing the digital video images by embedding information into the digital video image.

27. The video capture system of claim 21, further comprising processing the digital video images by detecting an object or a portion of an object in the video images, and delivering a signal in response to the detection.

28. The video capture system of claim 27, wherein the signal is delivered to an alarm that alerts a user of the object or portion of the object.

29. The video capture system of claim 27, wherein the signal is delivered to a mobile communication device.

30. The video capture system of claim 27, wherein the digital images are delivered to the local memory and the remote memory stored on a remote server wirelessly via a dongle coupled to the computing device.

31. A recordable medium comprising:
program instructions for capturing video images;
program instructions for directing the captured video images to (i) a local memory or (ii) the local memory and a remote memory; and
program instructions for assigning a priority to the captured video images and transferring the captured video images to (i) the local memory or to (ii) the local memory and the remote memory based on the priority of the images.

32. The recordable medium of claim 31, further comprising program instructions for alerting a user when a high priority video is captured.

33. The recordable medium of claim 31, further comprising program instructions for assigning a low priority to the captured video images and transferring the low priority captured video images to (i) the local memory or to (ii) the local memory and the remote memory after the high priority captured video images.

34. The recordable medium of claim 33, further comprising program instructions for compressing the low priority captured video images and transferring the compressed low priority captured video images to the local memory and the remote memory.

35. The recordable medium of claim 31, further comprising program instructions for receiving a signal from at least one of a motion detector, an alarm, an object recognition detector and any combination thereof and assigning a high priority to the captured video in response to the signal.

36. The recordable medium of claim 35, further comprising program instructions for transmitting the high priority captured video to the user.

37. The recordable medium of claim 35, further comprising program instructions for embedding data into the high priority captured video to enable a user to retrieve the high priority captured video without having to review relatively lower priority video.

38. A system comprising:
a camera for capturing video images;
an agent for directing the captured video images to (i) a local memory or (ii) the local memory and a remote memory; and
a controller for assigning a priority to the captured video images and transferring the captured video images to the local memory or to both the local memory and the remote memory based on the priority of the images.

39. The system of claim 38, wherein the agent is hardware, firmware, or software, or a combination of hardware, firmware and software, and wherein the controller receives a signal from at least one of a motion detector, an alarm, an object recognition detector and any combination thereof and assigning a high priority to the captured video in response to the signal, wherein the high priority captured video image is transferred to the remote memory before a low priority captured video.

40. The system of claim 38, wherein the agent compresses at least some of the video prior to transferring to the remote memory, or wherein the agent embeds data associated with the high priority captured digital video for retrieval.

41. An agent for an intelligent remote storage of video and audio surveillance data comprising:
a module for receiving digital video images and audio data;
the agent directing the captured video images and audio data to (i) a local memory or (ii) the local memory and a remote memory; and
the agent being hardware, software, firmware or a combination of hardware, software and firmware.

42. A process for an intelligent remote storage of video and audio surveillance data, the process comprising:
capturing digital video images and audio data; and
directing the captured video images and audio data to (i) a local memory or (ii) the local memory and a remote memory.
